(19) United States
(12) Patent Application Publication
(10) Pub. No.: US 2024/0015668 A1
(43) Pub. Date: Jan. 11, 2024

(54) COORDINATING PUNCTURING IN WIRELESS ACCESS POINTS

(71) Applicant: Cisco Technology, Inc., San Jose, CA (US)

(72) Inventors: Vishal S. DESAI, San Jose, CA (US); Brian D. HART, Sunnyvale, CA (US)

(21) Appl. No.: 18/054,884

(22) Filed: Nov. 11, 2022

Related U.S. Application Data
(60) Provisional application No. 63/368,017, filed on Jul. 8, 2022.

(51) Int. Cl. H04W 52/36; H04W 52/24; H04W 52/42

(52) U.S. Cl. CPC H04W 52/367; H04W 52/243; H04W 52/42

(57) ABSTRACT

A method includes grouping a plurality of access points based on a proximity of the plurality of access points to each other and determining, based on AFC reports for each of the plurality of access points, a first frequency band in which a threshold number of the plurality of access points are prevented from operating or are limited to operating at a first power that is lower than a maximum allowed standard power. The method also includes determining whether power cutoff in the first frequency band should be static or dynamic and if the power cutoff should be static, instructing the plurality of access points to use a portion of the first frequency band. The method further includes, if the power cutoff should be dynamic, instructing a first subset of the plurality of access points to operate at the first power in the first frequency band.

### CROSS-REFERENCE TO RELATED APPLICATIONS

This application claims benefit of co-pending U.S. provisional patent application Ser. No. 63/368,017 filed Jul. 8, 2022. The aforementioned related patent application is herein incorporated by reference in its entirety.

### TECHNICAL FIELD

Embodiments presented in this disclosure generally relate to wireless communications. More specifically, embodiments disclosed herein relate to coordinating puncturing in wireless access points.

### BACKGROUND

In wireless fidelity (WiFi) deployments, access points facilitate connections between user devices and the Internet or another network. In existing deployments, the access points may use automated frequency coordination (AFC) to determine the frequency bands that the access points may use to transmit without interfering with incumbent devices in the vicinity. The AFC system may also instruct the access points to transmit using a maximum allowed standard power in certain frequency bands while using a lower power in other frequency bands.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example controller in the system of FIG. 1 grouping access points.

FIG. 3 illustrates an example controller in the system of FIG. 1 coordinating puncturing.

FIG. 4 illustrates an example of puncturing in the system of FIG. 1.

FIG. 5 is a flowchart of an example method performed in the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

According to an embodiment, a method includes grouping a plurality of access points based on a proximity of the plurality of access points to each other and determining, based on AFC reports for each of the plurality of access points, a first frequency band in which a threshold number of the plurality of access points are prevented from operating or are limited to operating at a first power that is lower than a maximum allowed standard power. The method also includes determining whether power cutoff in the first frequency band should be static or dynamic and if the power cutoff in the first frequency band should be static, instructing the plurality of access points to use a portion of the first frequency band. The method further includes, if the power cutoff in the first frequency band should be dynamic, instructing a first subset of the plurality of access points to operate at the first power in the first frequency band.

According to another embodiment, an apparatus includes a memory and a processor communicatively coupled to the memory. The processor groups a plurality of access points based on a proximity of the plurality of access points to each other and determines, based on AFC reports for each of the plurality of access points, a first frequency band in which a threshold number of the plurality of access points are prevented from operating or are limited to operating at a first power that is lower than a maximum allowed standard power. The processor also determines whether power cutoff in the first frequency band should be static or dynamic and if the power cutoff in the first frequency band should be static, instructs the plurality of access points to use a portion of the first frequency band. The processor further, if the power cutoff in the first frequency band should be dynamic, instructs a first subset of the plurality of access points to operate at the first power in the first frequency band.

According to another embodiment, a non-transitory computer readable medium stores instructions that, when executed by a processor, cause the processor to assign a plurality of access points installed in a space to a group based on a proximity of the plurality of access points to each other in the space and based on whether the plurality of access points support multi-resource unit operation and determine, based on automated frequency coordination reports for each access point of the group, a first frequency band in which a threshold number of the access points of the group are prevented from operating or are limited to operating at a first power that is lower than a maximum allowed standard power. If a power cutoff in the first frequency band should be static, the processor instructs the access points of the group to use a portion of the first frequency band. If the power cutoff in the first frequency band should be dynamic, the processor instructs a first subset of the access points of the group to operate at the first power in the first frequency band.

### EXAMPLE EMBODIMENTS

Wireless fidelity (WiFi) access points may use automated frequency coordination (AFC) to determine the frequency bands that the access points can use to transmit without interfering with incumbent devices near the access points. The access points may receive reports from an AFC system that indicate the frequency bands in which the access points may transmit using a maximum allowed standard power and the frequency bands in which the access points should transmit using a lower power. In dense environments, there may be many incumbent devices near the access points, which may create numerous or large gaps in the frequencies and power budget allowances for the access points. As a result, the network performance may suffer.

The present disclosure describes a system that uses puncturing so that the access points are allowed to transmit using additional frequency bands. The system identifies and groups the access points based on proximity and other factors (e.g., whether the access points support puncturing or multi-resource unit (multi-RU) operation). The system then analyzes AFC reports for the grouped access points to determine frequency bands in which a threshold number (e.g., a majority) of the grouped access points may not use or may use at lower power. The system then determines whether static or dynamic puncturing should be used in these frequency bands to improve the performance of the access points. If static puncturing should be used, the system instructs the access points to use a portion of the frequency bands. If dynamic puncturing should be used, the system instructs a subset of the grouped access points to operate in the frequency bands at the lower power. In this manner, the system may allow some of the access points to use disallowed frequency bands, which improves network performance in certain embodiments.

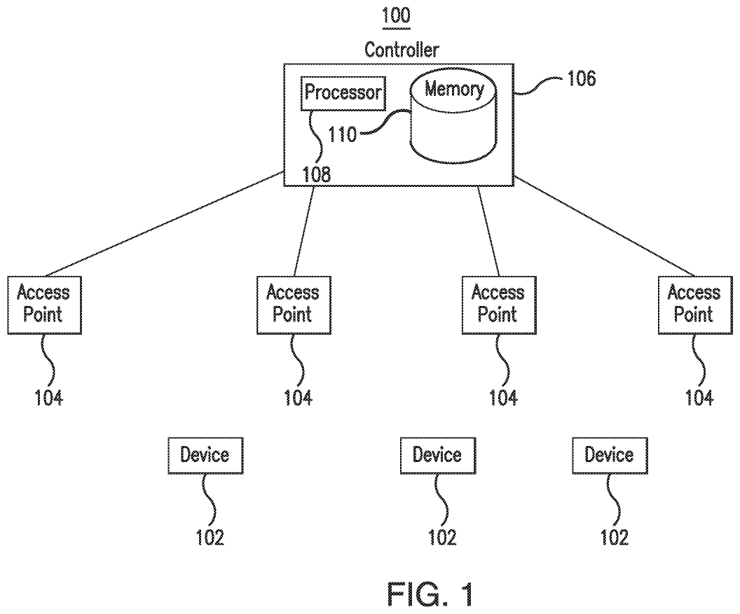

FIG. 1 illustrates an example system 100. As seen in FIG. 1, the system 100 includes one or more devices 102, one or more access points 104, and a controller 106. Generally, the devices 102 form wireless connections with the access points 104, and the controller 106 coordinates these connections. For example, the controller 106 may coordinate the frequency spectrum used by these connections.

The devices 102 may be any suitable devices that form wireless connections with the access points 104 to communicate with another network (e.g., the Internet). The devices 102 may transmit messages to the access points 104 and receive messages from the access points 104 over the wireless connections. As the devices 102 move throughout a space, the devices 102 may connect to different access points 104 based on the proximity of the devices 102 to the access points 104. Generally, a device 102 connects to an access point 104 that is physically closest to the device 102. As the device 102 moves to other positions or locations, the device 102 may move closer to other access points 104. The device 102 may then disconnect from the original access point 104 and connect to a closer access point 104.

The device 102 is any suitable device for communicating with components of the system 100. As an example and not by way of limitation, the device 102 may be a computer, a laptop, a wireless or cellular telephone, an electronic notebook, a personal digital assistant, a tablet, or any other device capable of receiving, processing, storing, or communicating information with other components of the system 100. The device 102 may be a wearable device such as a virtual reality or augmented reality headset, a smart watch, or smart glasses. The device 102 may also include a user interface, such as a display, a microphone, keypad, or other appropriate terminal equipment usable by the user. The device 102 may include a hardware processor, memory, or circuitry configured to perform any of the functions or actions of the device 102 described herein. For example, a software application designed using software code may be stored in the memory and executed by the processor to perform the functions of the device 102.

The access points 104 facilitate communications between the devices 102 and another network (e.g., the Internet). The access points 104 may form wireless connections with the devices 102 and then transmit messages to and receive messages from the devices 102 over these wireless connections. The access points 104 may be installed at different locations in a space. For example, the access points 104 may be installed at different areas of a building to provide network coverage for the building. The access points 104 may also be installed on different floors of the building to provide network coverage for the different floors.

The access points 104 may use an AFC system to determine the frequency bands that the access points 104 may use to form wireless connections with the devices 102. Additionally, the AFC system may inform the access points 104 of the transmission powers that the access points 104 may use in certain frequency bands. The access points 104 may provide their locations to the AFC system, and the AFC system may determine the incumbent devices that are within a particular distance of the access points 104. The AFC system may then determine the frequency bands and transmission powers that the access points 104 may use without interfering with the incumbent devices. If an access point 104 is deployed outdoors, then the AFC system may allow the access point to use a maximum allowed standard power to transmit messages to connected devices 102. If the access point 104 is installed indoors, to reduce interfering with incumbent devices, the AFC system may instruct the access point 104 to use a transmission power that is lower than the maximum allowed standard power to transmit messages to connected devices 102 in certain frequency bands.

Some of the access points 104 may support multi-RU operation (which may be referred to as puncturing). When an access point 104 supports puncturing, the access point 104 may use certain sub-frequency bands even though other sub-frequency bands in the frequency band are not allowed to be used. For example, if the AFC system informs the access point 104 that a 20-megahertz sub-frequency band of a band is not allowed to be used, the access point 104 may continue to use the other 20-megahertz sub-frequency band instead of refraining from using the entire band.

The controller 106 coordinates the access points 104. For example, the controller 106 may coordinate the puncturing used by the various access points 104. The controller 106 may instruct certain access points 104 to perform static puncturing, and the controller 106 may instruct some access points 104 to use dynamic puncturing. As seen in FIG. 1, the controller 106 includes a processor 108 and a memory 110, which are configured to perform the actions or functions of the controller 106 described herein.

The processor 108 is any electronic circuitry, including, but not limited to one or a combination of microprocessors, microcontrollers, application specific integrated circuits (ASIC), application specific instruction set processor (ASIP), and/or state machines, that communicatively couples to memory 110 and controls the operation of the controller 106. The processor 108 may be 8-bit, 16-bit, 32-bit, 64-bit or of any other suitable architecture. The processor 108 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 108 may include other hardware that operates software to control and process information. The processor 108 executes software stored on the memory 110 to perform any of the functions described herein. The processor 108 controls the operation and administration of the controller 106 by processing information (e.g., information received from the devices 102, access points 104, and memory 110). The processor 108 is not limited to a single processing device and may encompass multiple processing devices.

The memory 110 may store, either permanently or temporarily, data, operational software, or other information for the processor 108. The memory 110 may include any one or a combination of volatile or non-volatile local or remote devices suitable for storing information. For example, the memory 110 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 110, a disk, a CD, or a flash drive. In particular embodiments, the software may include an application executable by the processor 108 to perform one or more of the functions described herein.

The controller 106 may assess the locations and capabilities of each of the access points 104 in the system 100. For example, the controller 106 may determine the access points 104 that are installed close to each other. As another example, the controller 106 may determine the access points 104 that are installed at similar heights (e.g., on the same floor of a building as each other). The controller 106 may also determine the access points 104 that support multi-RU operation or puncturing and the access points 104 that do not support multi-RU operation or puncturing. As another example, the controller 106 may determine the access point 104 that support transmissions at the maximum allowed standard power. For example, the controller 106 may determine the access points 104 that are installed outdoors and the access points 104 that are installed indoors but include radios that may transmit at the maximum allowed standard power.

The controller 106 may generate a candidate list of access points 104 in the system 100 that support multi-RU operation and that may transmit at the maximum allowed standard power. For each candidate on the list, the controller 106 may determine the access points 104 that are proximate or close to the candidate. For example, the controller 106 may determine the access points 104 that are near the candidate or that are installed on the same floor or height as the candidate. In some embodiments, the controller 106 determines only the candidate access points 104 in the list that are near or installed on the same floor or height as the candidate. The controller 106 may then group these access points 104 together with the candidate and assess the percentage of the access points 104 in the group that support multi-RU operation. As a result, the controller 106 generates groups of access points 104 that are near each other or installed at the same height as each other, and a percentage of these access points 104 in the group support multi-RU operation. Some of the groups may have a higher number of access points 104 that support multi-RU operation and that are capable of transmitting at the maximum allowed standard power.

For each group of access points 104, the controller 106 may analyze the AFC reports for the access points 104 in the group to determine the historical allowed operation of the access points 104 in the group. For example, the controller 106 may determine the frequency bands that the access points 104 were allowed or not allowed to use. Additionally, the controller 106 may determine the frequency bands in which the access points 104 were allowed to transmit using a transmission power lower than the maximum allowed standard power. In some embodiments, the controller 106 may determine the 20-megahertz frequency bands in which a threshold number (e.g., a majority) of the access points 104 in the group are disallowed from using or in which the threshold number of the access points 104 are limited to using at the lower power. The controller 106 may tag these frequency bands for subsequent analysis.

The controller 106 may then analyze the performance of the access points 104 in the group to determine whether puncturing should be used for any of the tagged frequency bands. For example, the controller 106 may evaluate the performance of the access points 104 in the group in the allowed frequency bands. If the controller 106 determines that the access points 104 in the group may experience improved performance if additional frequency bands are available, the controller 106 may allow some of the tagged frequency bands to be used. For example, if the access points 104 in the group have higher bandwidth requirements, then the controller 106 may allow static puncturing of some of the tagged frequency bands, which may allow for a wider bandwidth for the access points 104 in the group. As another example, if the density of the access points 104 in the group would limit the amount of spectrum available to the access points 104 such that spectrum scarcity becomes an issue for the access points 104 in the group, then the controller 106 may allow some of the access points 104 to use dynamic puncturing for some of the tagged frequency bands. These access points 104 may then operate in the tagged frequency bands at a lower power. In this manner, the controller 106 coordinates the puncturing of frequency bands across the access points 104, which may improve the network performance in certain embodiments.

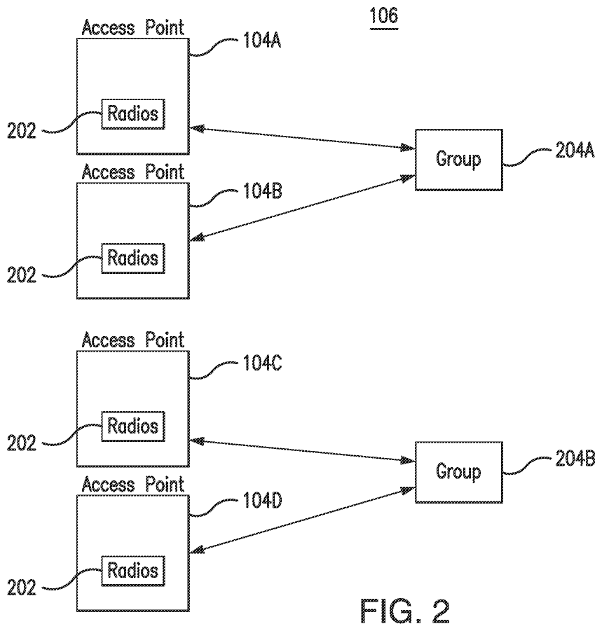

FIG. 2 illustrates an example controller 106 in the system 100 of FIG. 1 grouping access points 104. In the example of FIG. 2, the controller 106 groups access points 104 based on their locations and capabilities. The controller 106 may then use these groups of access points 104 to coordinate puncturing in the system 100.

Each access point 104 includes one or more radios 202. In the example of FIG. 2, each of the access points 104A, 104B, 104C, and 104D include one or more radios 202. Some of the access points 104 may include radios 202 that support multi-RU operation or puncturing, and some access points 104 may include radios 202 that do not support multi-RU operation or puncturing. Additionally, some of the access points 104 may include radios 202 that can transmit at the maximum allowed standard power, and some of the access points 104 may include radios 202 that cannot transmit at the maximum allowed standard power.

The controller 106 groups the access points 104 based on their locations and capabilities. For example, the controller 106 may first identify the access points 104 that include radios 202 that support multi-RU operation and that can transmit at the maximum allowed standard power. The controller 106 may then determine for each of these identified access points 104, the access points 104 that are installed near or at the same height as the identified access point. The controller 106 then groups these access points 104. In the example of FIG. 2, the controller 106 generates a group 204A that includes the access point 104A and the access point 1048. The controller 106 also generates a group 204B that includes the access point 104C. The access points 104A and 104B may have been added to the group 204A because the access point 104A includes radios 202 that support multi-RU operation and that can transmit at the maximum allowed standard power, and because the access point 104B is installed near the access point 104A. The access point 104C may have been added to the group 204B because the access point 104C includes radios that support multi-RU operation and that can transmit at the maximum allowed standard power. The access points 104A, 104B, and 104D may not be installed near the access point 104C, and thus, the access points 104A, 104B, and 104D may not be added to the group 204B with the access point 104C. The controller 106 may use the groups 204 of access points 104 to determine whether the access points 104 in a group 204 should be allowed to puncture certain frequency bands.

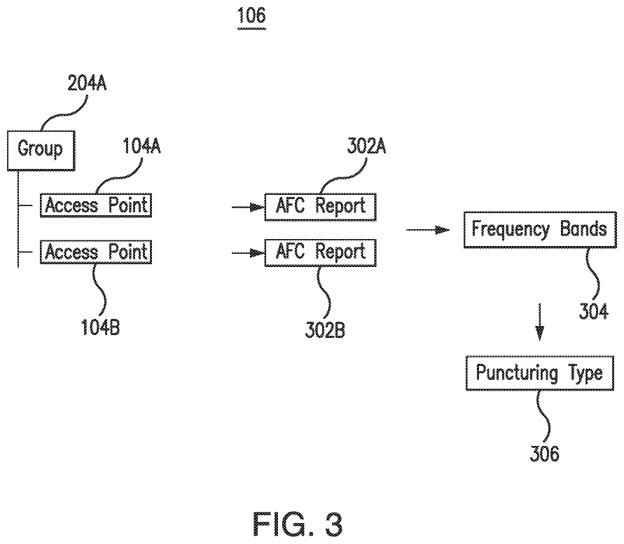

FIG. 3 illustrates an example controller 106 in the system 100 of FIG. 1 coordinating puncturing. Generally, the controller 106 assesses the historical restrictions and performance of the access points 104 in a group 204 to coordinate the puncturing used by the access points 104 in the group 204.

As seen in FIG. 3, the controller 106 assesses the access points 104A and 104B in the group 202A. Other access points 104 may also be assigned to the group 202A. The controller 106 reviews the AFC reports 302 for the access points 104 in the group 202A. For example, the controller 106 may review the AFC report 302A for the access point 104A and the AFC report 302B for the access point 1048. The AFC report 302A may indicate the frequency bands that the access point 104A is allowed or not allowed to use. The AFC report 302B may indicate the frequency bands that the access point 104B is allowed or not allowed to use. Additionally, the AFC report 302A may indicate the frequency bands in which the access point 104A is allowed to use the maximum allowed standard power and the frequency bands in which the access point 104A is limited to using a lower power. The AFC report 302B may indicate the frequency bands in which the access point 104B is allowed to use the maximum allowed standard power and the frequency bands in which the access point 104B is limited to using a lower power.

The controller 106 may identify from the AFC reports 302 the frequency bands 304 that a threshold number (e.g., a majority) of the access points 104 in the group 204 are not allowed to use. Additionally, the controller 106 may identify the frequency bands 304 in which the threshold number of the access points 104 in the group 204 are limited to using a lower power. The controller 106 may tag these frequency bands 304. In some embodiments, the controller 106 implements a power threshold that is lower than the maximum allowed standard power. The controller 106 may identify the frequency bands 304 in which the threshold number of the access points 104 in the group 204 are limited to using a power that is lower than the power threshold. Stated differently, if the access points 104 are limited to using a lower power in a certain frequency band, but this lower power does not fall below the power threshold, then the controller 106 may not tag this frequency band as a frequency band 304. As a result, the tagged frequency bands 304 include the frequency bands that the threshold number of the access points 104 in the group 204 are not allowed to use and the frequency bands in which the threshold number of the access points 104 in the groups 204 are limited using a lower power (e.g., a power that falls below the power threshold set by the controller 106).

The controller 106 may set the power threshold in any suitable manner. For example, the controller 106 may set the power threshold as a static threshold or as a dynamic threshold. The controller 106 may set the power threshold according to the density of the access points 104 in the group 204. For example, if the access points 104 in the group 204 are installed closer to each other (and thus, have a higher density), the controller 106 may set a lower power threshold. If the access points 104 in the group 204 are installed high above the floor, then the controller 106 may set a higher power threshold to provide better network coverage. The controller 106 may set the power threshold according to a service level agreement of the access points 104 in the group 204. The controller 106 may set a higher power threshold, if the access points 104 in the group 204 have more demanding or stringent service level agreements.

The controller 106 may then determine a puncturing type 306 for the tagged frequency bands 304. For example, the controller 106 may determine whether a tagged frequency band 304 should be punctured and whether the tagged frequency band 304 should be statically punctured or dynamically punctured. The controller 106 may assess the performance and needs of the access points 104 in the group 204 to determine whether the tagged frequency band 304 should be statically punctured or dynamically punctured. The controller 106 may assess the performance of the access points 104 in the group 204 using the untagged frequency bands. In the untagged frequency bands, the access points 104 in the group 204 are typically allowed to transmit at the maximum allowed standard power. If the performance of the access points 104 of the group 204 in the untagged frequency bands is not satisfactory, then the controller 106 may allow some of the tagged frequency bands 304 to be punctured to improve performance.

As an example, if the access points 104 in the group 204 are subject to high bandwidth requirements and the performance of the access points 104 in the group 204 in the untagged frequency bands does not satisfy these high bandwidth requirements, then the controller 106 may allow some of the tagged frequency bands 304 to be statically punctured. For example, the AFC reports 302 may indicate that the access points 104 in the group 204 are allowed to transmit in a particular frequency band using the maximum allowed standard power. The controller 106 may instruct the access points 104 to transmit in that frequency band using the maximum allowed power. The controller 106 may then assess whether the access points 104 are satisfying the high bandwidth requirements. For example, the access points 104 may not be satisfying the high bandwidth requirements due to interference or channel usage in the frequency band. In response, the controller 106 may instruct the access points 104 to use static puncturing. During static puncturing, the controller 106 may instruct the access points 104 in the group 204 to puncture a tagged frequency band 304. As a result, the access points 104 in the group 204 may use a sub-frequency band of the tagged frequency band 304 (e.g., by transmitting at the maximum allowed standard power in the sub-frequency band) while refraining from using another, adjacent sub-frequency band of the tagged frequency band. In this manner, the controller 106 may provide wider channel utilization, which may allow the access points 104 to satisfy their high bandwidth requirements.

As another example, the controller 106 may determine that some of the tagged frequency bands 304 may be dynamically punctured by some of the access points 104 in the group 204. In some embodiments, the controller 106 may determine that dynamic puncturing should be used to avoid spectrum scarcity. For example, when the spatial density of the access points 104 in the group 204 is high, the amount of disallowed frequency bands may also be high, which may result in spectrum scarcity. The controller 106 may determine that dynamic puncturing should be used due to the spatial density of the access points 104 in the group 204. To avoid spectrum scarcity, the controller 106 may use dynamic puncturing to allow some of the access points 104 in the group 204 to transmit over a tagged frequency band 304 using a lower power. As a result, some of the access points 104 in the group 204 may be allowed to use a tagged frequency band 304, which may provide additional spectrum to the access points 104 in the group 204. In some embodiments, the controller 106 does not instruct all of the access points 104 in the group 204 to use dynamic puncturing. As a result, some of the access points 104 in the group 204 use dynamic puncturing and transmit over the tagged frequency band 304 using the lower power while other access points 104 in the group 204 refrain from transmitting in the tagged frequency band 304.

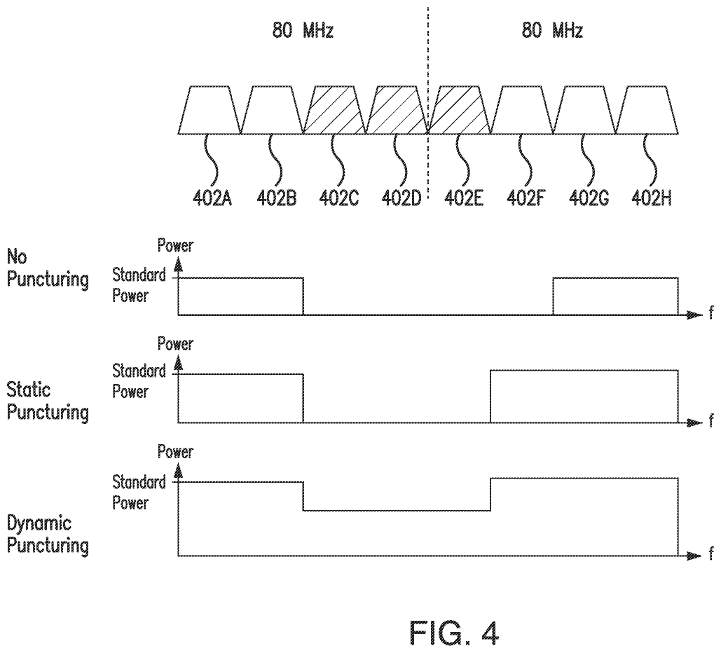

FIG. 4 illustrates an example of puncturing in the system 100 of FIG. 1. In the example of FIG. 4, different examples of puncturing are illustrated using a 160-megahertz frequency band formed using the sub-frequency bands 402A, 402B, 402C, 402D, 402E, 402F, 402G, and 402H. Each of the sub-frequency bands 402A, 402B, 402C, 402D, 402E, 402F, 402G, and 402H may be 20-megahertz sub-frequency bands. Additionally, the sub-frequency bands 402A and 402B may form a 40-megahertz sub-frequency band, the sub-frequency bands 402C and 402D may form a 40-megahertz sub-frequency band, the sub-frequency bands 402E and 402F may form a 40-megahertz sub-frequency band, and the sub-frequency bands 402G and 402H may form a 40-megahertz sub-frequency band.

As seen in FIG. 4, the sub-frequency bands 402C, 402D, and 402E include a cross-hatching pattern indicating that these sub-frequency bands 402C, 402D, and 402E are not allowed to be used by an AFC system. In other words, an access point 104 may not use the sub-frequency bands 402C, 402D, and 402E to transmit messages. If 40-megahertz channels are used, then the sub-frequency bands 402A and 402B may form a first channel, the sub-frequency bands 402C and 402D may form a second channel, the sub-frequency bands 402E and 402F may form a third channel, and the sub-frequency bands 402G and 402H may form a fourth channel. When no puncturing is used, the access point 104 is allowed to transmit using the maximum allowed standard power in the sub-frequency bands 402A, 402B, 402G, and 402H. In other words, the 40-megahertz channels formed by the sub-frequency bands 402A and 402B and the sub-frequency bands 402G and 402H may be used for the maximum allowed standard power. The access point 104 does not use the 40-megahertz channel formed by the sub-frequency bands 402C and 402D. Additionally, the access point 104 does not use the 40-megahertz channel formed by the sub-frequency bands 402E and 402F even though the access point 104 is allowed to transmit using the sub-frequency band 402F.

When static puncturing is used, the controller 106 may instruct the access point 104 to not use the sub-frequency bands 402C, 402D, and 402E and to use the sub-frequency bands 402A, 402B, 402F, 402G, and 402H. In response, the access point 104 transmits at the maximum allowed standard power in the sub-frequency bands 402A, 402B, 402F, 402G, and 402H. As a result, the access point 104 has a wider channel utilization than when no puncturing is used.

When dynamic puncturing is used, the controller 106 instructions the access point 104 to transmit at a lower power in the sub-frequency bands 402C, 402D, and 402E. In response, the access point 104 transmits at the maximum allowed standard power in the sub-frequency bands 402A, 402B, 402F, 402G, and 402H. Additionally, the access point 104 transmits at a lower power in the sub-frequency bands 402C, 402D, and 402E. As a result, the access point 104 has an even wider channel utilization relative to when static puncturing is used.

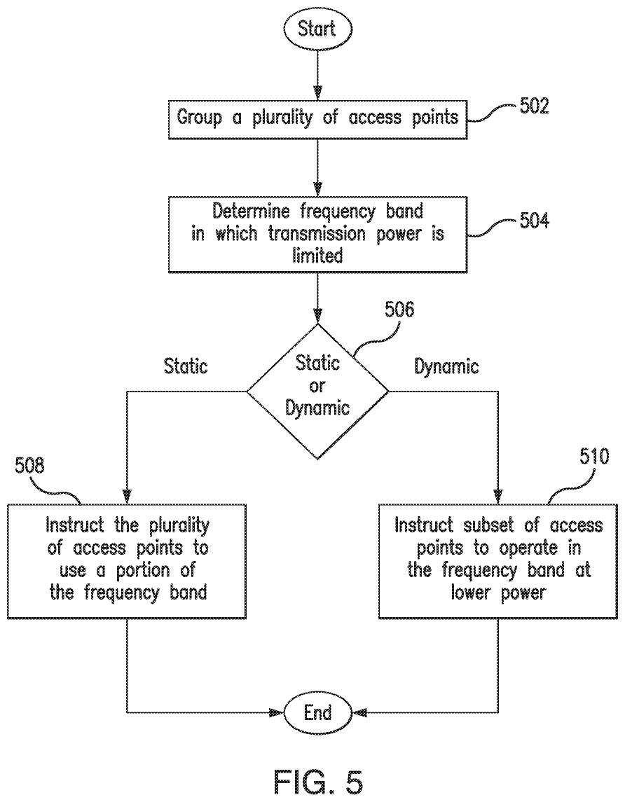

FIG. 5 is a flowchart of an example method 500 performed in the system 100 of FIG. 1. In particular embodiments, the controller 106 performs the method 500. By performing the method 500, the controller 106 coordinates the puncturing used in certain access points 104 in the system 100.

In block 502, the controller 106 groups a plurality of access points 104. For example, the controller 106 may identify the access points 104 that support multi-RU operation or puncturing and that can transmit at the maximum allowed standard power. The controller 106 then determines for each identified access point 104, the access points 104 that are near the identified access point 104 or installed at a similar height as the identified access point 104. The controller 106 then groups these access points 104 with the identified access point 104 in a group 204. As a result, a large percentage of the group 204 may be access points 104 that support multi-RU operation and can transmit at the maximum allowed standard power.

In block 504, the controller 106 determines a frequency band 304 in which transmission power is limited or not allowed. The controller 106 may determine the frequency band 304 by analyzing the AFC reports 302 for the access points 104 in the group 204. The AFC reports 302 may indicate the frequency bands that the access points 104 are allowed or not allowed to use. Additionally, the AFC reports 302 may indicate the frequency bands in which the access points 104 may transmit at the maximum allowed standard power or a lower power. The frequency band 304 may be a frequency band in which a threshold number (e.g., a majority) of the access points 104 in the group 204 are not allowed to use. Alternatively, the frequency band 304 may be a frequency band in which the threshold number of the access points 104 in the group 204 may transmit using a lower power that falls below a power threshold set by the controller 106. The controller 106 may set the power threshold in any suitable manner.

The controller 106 may then determine whether the frequency band 304 should be statically or dynamically punctured in block 506. For example, if the access points 104 in the group 204 have high bandwidth requirements, then the controller 106 may determine that the frequency band 304 should be statically punctured. In block 508, the controller 106 may instruct the access points 104 to use static puncturing and to use a portion of the frequency band 304. In response, the access points 104 may transmit in the frequency band 304 but using only a portion of the sub-frequency bands in the frequency band 304. In this manner, the access points 104 are allowed to use frequency bands that may fall into the same channel as the frequency band 304 rather than refraining from using every frequency band in the same channel as the frequency band 304, which may increase the channel utilization and the amount of bandwidth available to the access points 104.

As another example, the controller 106 may determine, based on the density of the access points 104, that the access points 104 may experience spectrum scarcity. In response, the controller 106 may determine that the frequency band 304 should be dynamically punctured. In block 510, the controller 106 instructs a subset of the access points 104 in the group 204 to use dynamic puncturing and to operate in the frequency band 304 at a lower power. In response, the subset of access points 104 may begin transmitting in the frequency band 304 using a lower power. As a result, more spectrum is made available to the access points 104, and channel utilization is increased, in certain embodiments.

In summary, a system 100 uses puncturing so that the access points 104 are allowed to transmit using additional frequency bands. The system 100 identifies and groups the access points 104 based on proximity and other factors (e.g., whether the access points 104 support puncturing or multi-resource unit (multi-RU) operation). The system 100 then analyzes the AFC reports 302 for the grouped access points 104 to determine frequency bands 304 in which a threshold number (e.g., a majority) of the grouped access points 104 may not use or may use at lower power. The system 100 then determines whether static or dynamic puncturing should be used in these frequency bands 304 to improve the performance of the access points 104. If static puncturing should be used, the system 100 instructs the access points 104 to use static puncturing and to use a portion of the frequency bands 304. If dynamic puncturing should be used, the system instructs a subset of the grouped access points to operate in the frequency bands at the lower power. In this manner, the system may allow some of the access points to use disallowed frequency bands, which improves network performance in certain embodiments.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
grouping a plurality of access points based on a proximity of the plurality of access points to each other;
determining, based on automated frequency coordination reports for each of the plurality of access points, a first frequency band in which a threshold number of the plurality of access points are prevented from operating or are limited to operating at a first power that is lower than a maximum allowed standard power;
determining whether power cutoff in the first frequency band should be static or dynamic;
if the power cutoff in the first frequency band should be static, instructing the plurality of access points to use a portion of the first frequency band; and
if the power cutoff in the first frequency band should be dynamic, instructing a first subset of the plurality of access points to operate at the first power in the first frequency band.

2. The method of claim 1, further comprising:
determining a second frequency band in which the plurality of access points are allowed to operate at the maximum allowed standard power; and
instructing the plurality of access points to operate at the maximum allowed standard power in the second frequency band.

3. The method of claim 2, wherein determining whether the power cutoff in the first frequency band should be static or dynamic is based at least in part upon an interference level or a channel usage in the second frequency band.

4. The method of claim 1, wherein determining whether the power cutoff in the first frequency band should be static or dynamic is based at least in part upon a spatial density of the plurality of access points.

5. The method of claim 1, wherein determining whether the power cutoff in the first frequency band should be static or dynamic is based at least in part upon a height at which the plurality of access points are installed.

6. The method of claim 1, wherein determining whether the power cutoff in the first frequency band should be static or dynamic is based at least in part upon a service level requirement for the plurality of access points.

7. The method of claim 1, wherein the plurality of access points are installed indoors.

8. The method of claim 1, further comprising instructing a second subset of the plurality of access points to refrain from operating in the first frequency band if the power cutoff in the first frequency band should be dynamic.

9. An apparatus comprising:
a memory; and
a processor communicatively coupled to the memory, the processor configured to:
group a plurality of access points based on a proximity of the plurality of access points to each other;
determine, based on automated frequency coordination reports for each of the plurality of access points, a first frequency band in which a threshold number of the plurality of access points are prevented from operating or are limited to operating at a first power that is lower than a maximum allowed standard power;
determine whether power cutoff in the first frequency band should be static or dynamic;
if the power cutoff in the first frequency band should be static, instruct the plurality of access points to use a portion of the first frequency band; and
if the power cutoff in the first frequency band should be dynamic, instruct a first subset of the plurality of access points to operate at the first power in the first frequency band.

10. The apparatus of claim 9, wherein the processor is further configured to:
determine a second frequency band in which the plurality of access points are allowed to operate at the maximum allowed standard power; and
instruct the plurality of access points to operate at the maximum allowed standard power in the second frequency band.

11. The apparatus of claim 10, wherein determining whether the power cutoff in the first frequency band should be static or dynamic is based at least in part upon an interference level or a channel usage in the second frequency band.

12. The apparatus of claim 9, wherein determining whether the power cutoff in the first frequency band should be static or dynamic is based at least in part upon a spatial density of the plurality of access points.

13. The apparatus of claim 9, wherein determining whether the power cutoff in the first frequency band should be static or dynamic is based at least in part upon a height at which the plurality of access points are installed.

14. The apparatus of claim 9, wherein determining whether the power cutoff in the first frequency band should be static or dynamic is based at least in part upon a service level requirement for the plurality of access points.

15. The apparatus of claim 9, wherein the plurality of access points are installed indoors.

16. The apparatus of claim 9, further comprising instructing a second subset of the plurality of access points to refrain from operating in the first frequency band if the power cutoff in the first frequency band should be dynamic.

17. A non-transitory computer readable medium storing instructions that, when executed by a processor, cause the processor to:
assign a plurality of access points installed in a space to a group based on a proximity of the plurality of access points to each other in the space and based on whether the plurality of access points support multi-resource unit operation;
determine, based on automated frequency coordination reports for each access point of the group, a first frequency band in which a threshold number of the access points of the group are prevented from operating or are limited to operating at a first power that is lower than a maximum allowed standard power;
if a power cutoff in the first frequency band should be static, instruct the access points of the group to use a portion of the first frequency band; and
if the power cutoff in the first frequency band should be dynamic, instruct a first subset of the access points of the group to operate at the first power in the first frequency band.

18. The medium of claim 17, wherein the processor further:
determines a second frequency band in which the access points of the group are allowed to operate at the maximum allowed standard power; and
instructs the access points of the group to operate at the maximum allowed standard power in the second frequency band.

19. The medium of claim 18, wherein whether the power cutoff in the first frequency band should be static or dynamic is based at least in part upon an interference level or a channel usage in the second frequency band.

20. The medium of claim 17, wherein whether the power cutoff in the first frequency band should be static or dynamic is based at least in part upon a spatial density of the access points of the group.
